(19) United States
(12) Patent Application Publication
(10) Pub. No.: US 2017/0109701 A1
(43) Pub. Date: Apr. 20, 2017

(54) SYSTEM AND METHOD FOR TARGETING DIGITAL ADVERTISEMENTS

(71) Applicants: Abhijit KHASNIS, BANGALORE (IN); Manjunath Sannappa TALWAR, BANGALORE (IN)

(72) Inventors: Abhijit KHASNIS, BANGALORE (IN); Manjunath Sannappa TALWAR, BANGALORE (IN)

(73) Assignee: ABHIMAN TECHNOLOGIES PRIVATE LIMITED, BANGALORE (IN)

(21) Appl. No.: 14/883,649

(22) Filed: Oct. 15, 2015

(51) Int. Cl. G06Q 10/10; G06Q 50/00; G06Q 30/02

(52) U.S. Cl. CPC G06Q 10/1053; G06Q 30/0269; G06Q 50/01; G06Q 30/0264

(57) ABSTRACT

A system and method for targeting digital advertisements are provided. The system (100) includes one or more processors (102) configured to gather information corresponding to search parameters used by a first user device (200), identify a company to which the first user device (200) corresponds to or a company in which user of the first user device (200) is employed, and customize advertisement at least based on the search parameters and insight derived about the identified company.

### BACKGROUND

Unless otherwise indicated herein, the materials described in this section are not prior art to the claims in this application and are not admitted to be prior art by inclusion in this section.

The present invention relates generally to digital advertising, and more particularly but not exclusively to customized digital advertisements and technique for targeting such customized digital advertisements to potential users, such as recruiters.

Advertisement helps to promote products or services, and at the same time helps individuals gain awareness and knowledge about products or services. Among various forms of advertising, digital advertising has proven to be among one of the most cost efficient and effective techniques of advertising in several fields of commerce.

Several industries rely heavily on digital advertisement campaigns to reach out to its target base. Digital advertisement enabling platforms enable advertisers to target their advertisements based on various parameters. As an example, advertisements are targeted based on search parameters entered by a user/searcher, location of a user, age and gender of a user, among other parameters.

The above discussed parameters may enable advertisers to target a niche set of users and may even enable the advertisers to customize their advertisements based on targeted users. However, on many occasions, several users may find the advertisements irrelevant or non—persuasive. As an example, a searcher, such as a recruiter who has searched for job seekers having a specific skill set, might be targeted with an advertisement that indicates presence of such candidates in a job portal who are expecting a certain salary. However, if the expected salary is beyond the salary generally offered by the recruiter's company, then the recruiter may not be interested in the advertisement. In another similar example, the recruiter who might be interested in recruiting a few candidates may be bombarded with advertisements, which may lead to low return on investment from such targeted advertisement.

In light of the foregoing discussion there is a need for a technique for customizing digital advertisements and technique for targeting such customized digital advertisements to potential users, such as recruiters.

### SUMMARY

An embodiment provides a system for targeting digital advertisements. The system includes one or more processors configured to gather information corresponding to search parameters used by a first user device, identify a company to which the first user device corresponds to or a company in which user of the first user device is employed, and customize advertisement at least based on the search parameters and insight derived about the identified company.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 for customizing and targeting digital advertisements, in accordance with an embodiment;

FIG. 2 is an exemplary block diagram of the exemplary system 100 for customizing and targeting digital advertisements, in accordance with an embodiment; and

FIG. 3 is a flow chart of an exemplary method for customizing and targeting digital advertisements, in accordance with an embodiment.

### DETAILED DESCRIPTION

In accordance with at least one embodiment a system is provided for targeting digital advertisement. A recruiter may have carried out a search to identify job seekers with a specific skill set using a search engine. The search engine, in the results, may have pointed to a webpage (webpage of a job portal which is using the system) of the system. Subsequently, the recruiter may have landed on the webpage of the system, at which point the system may gather/use information such as search parameters entered by the recruiter, device information of the recruiter and network information corresponding to the device used by the recruiter to access the webpage. The system may then identify the company to which the searcher/recruiter works with. Subsequently, the system may use insight about the company and the search parameters entered by the recruiter to customize digital advertisements, which may then be targeted at the recruiter or the company in which the recruiter is employed. The system may also customize the targeting strategy, such as frequency of advertizing and time of displaying advertizing, among others.

The following detailed description includes references to the accompanying drawings, which form part of the detailed description. The drawings show illustrations in accordance with example embodiments. These example embodiments are described in enough detail to enable those skilled in the art to practice the present subject matter. However it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is therefore, not to be taken as a limiting sense.

In this document, the terms “a” or “an” are used, as in common in patent documents, to include one or more than one. In this document, the term “or” is used to refer to a non-exclusive “or”, such that “A or B” includes “A but not B”, and “A and B”, unless otherwise indicated.

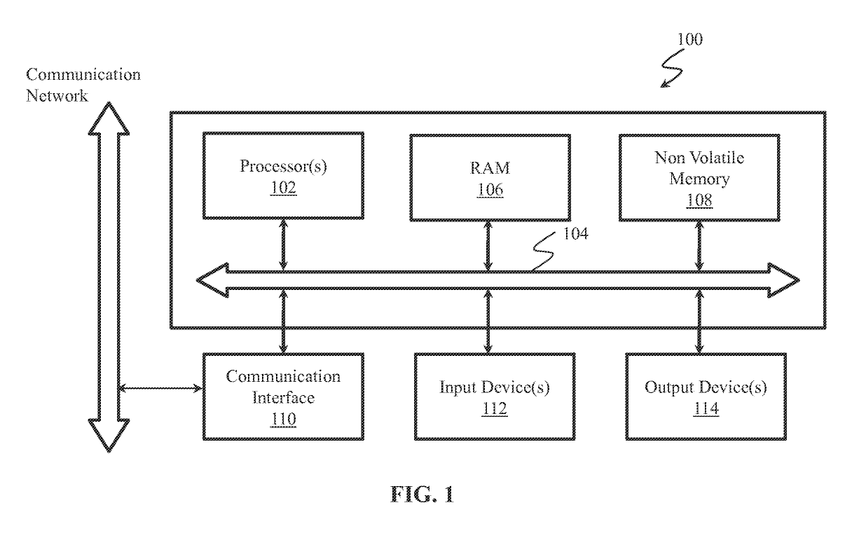

Referring to the figures, more particularly to FIG. 1, an exemplary architecture of an exemplary system 100 is provided for customizing and targeting digital advertisements. The system 100 may be one or more server and may include one or more processors 102, a bus system 104, a random access memory 106, a disk drive or non-volatile memory 108, a communication interface 110, input device(s) 112 and output device(s) 114.

The processor 102 may be any hardware which returns output by accepting signals, such as electrical signals as input. In one embodiment, processors 102 may include one or more computer processing units (CPUs) The processor(s) 102 may communicate with a number of peripheral devices via the bus subsystem 104. The processor(s) 102 may be implemented as appropriate in hardware, computer-executable instructions, firmware, or combinations thereof Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

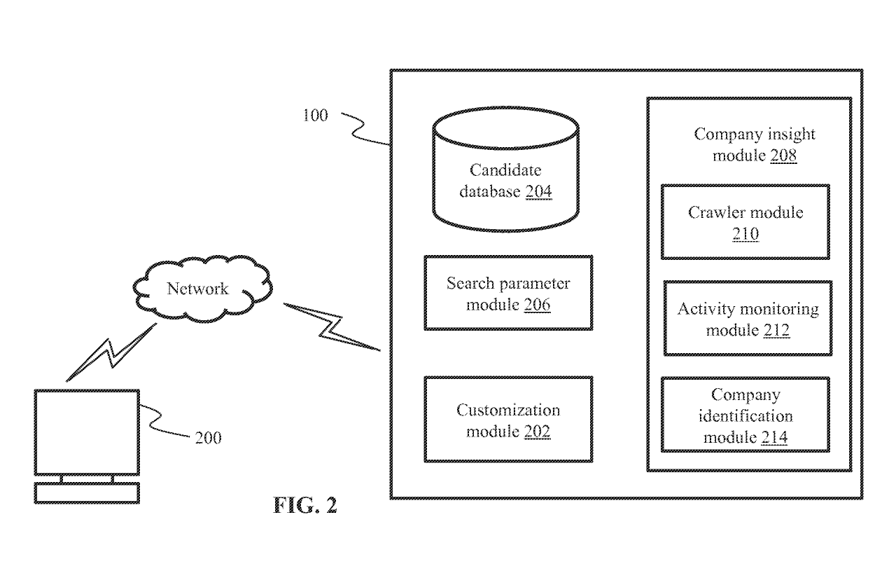

Now also referring to FIG. 2, the system 100 may communicate directly or indirectly with a first user device 200. The first user device 200 may be used by a user, such as a recruiter working for a company. The first user device 200 may be any type of computing device such as, but not limited to, a mobile phone, a smart phone, a personal digital assistant (PDA), a laptop computer, a desktop computer, a server computer, a thin-client device and a tablet PC, among other such devices.

The system 100 may include a customization module 202, a candidate database 204, a search parameter module 206 and a company insight module 208. The company insight module 208 may include a crawler module 210, an activity monitoring module 212 and a company identification module 214.

The customization module may include a set of instructions, which when executed by the processor(s) 102 causes the processor to customize digital advertisements and customize strategy for targeting the customized digital advertisements.

The candidate database 204 may include profiles of candidates, such as job seekers. The candidate database 204 may include information such as, education qualification details, details of companies the candidate has worked with previously, period of employment with various companies, skill related information, salary being drawn by the candidate currently, salary/salaries being drawn by the candidate in one or more companies the candidate was employed previously, current location of the candidate, date of joining a company who has offered the candidate a job and candidate preference(s), among others. Candidate preference information may include information indicating interest of the candidate in working with one or more companies, disinterest of the candidate in working with one or more companies, preferred salary of the candidate and location(s) preferred by the candidate to work in future, among others.

The search parameter module 206 may receive search parameters used by a user/searcher/recruiter to identify candidates whose profiles match the search parameters. The search parameter module 206 may receive search parameters from the first user device 200 when the user of the device 200 accesses webpage(s) of the system 100 and carries out a search in the webpage(s). As an example, the user of the device 200 access a webpage belonging to a job portal and carries out a search using the webpage. The search parameters of the search may be, as an example, may include, “JAVA programmers with 2 years of experience Who are currently located in Bangalore”. The search may be in the form of a sentence, as illustrated above or may be in a format that allows selection of search parameters or entering of search parameters in specific fields.

Alternatively or in addition, the search parameter module 206 may receive or may use search parameters present on the first user device 200. The search parameters may be present on the first user device 200 in the form of cookies. The search parameter module 206 may access the cookies when the first user device 200 accesses webpage(s) of the system 100. The search parameters may also include website addresses, such as addresses of job portals, and the time and/or duration of having accessed such job portals.

Alternatively or in addition to one or more of the above discussed methodologies, the search parameter module 206 may receive or may use search parameters available to systems, such as social networking platforms or search engines, which may be independent of the system 100.

The company insight module 208, in an embodiment includes instructions, which when executed by the processor(s) 102, causes the processor(s) 102 to determine the sentiment and preferences of the company in which the searcher/recruiter is working. The company insight module 208 includes the company identification module 214 which is configured to determine the company in which the user of the first user device 200 is working. The company identification module 211 may use the first user device's network information to identify the company to which the first user device 200 corresponds. The information about the network, which the first user device 200 uses to communicate with other devices, may be received by the company identification module 214 when the first user device 200 communicates with the system 100.

The company identification module 214 may gather the network information corresponding to the first user device 200 from one or more internet service providers. The network information may be extracted by the company identification module 214 whenever the first user device 200 communicates with the system 100. Upon extraction of the network information, the system 100 may communicate with an internet service provider to identify the company that may be associated with the extracted network information.

The network information may include a network address, a device address, such as the IP address corresponding to a device. Devices with similar IP addresses may be connected with one server over one particular internet network. Such devices may correspond to one single company or one single entity.

Alternatively or in addition, the company identification module 214 may identify or use company information about the user of the device 200 from a system, which may be independent of the system 100. Such a system that may be able to identify company information about the user of the device 200 may include asocial networking system or a search engine. As an example, the user of the device 200 may have logged on to asocial networking platform in which the user may have submitted information about the company in which the user is employed. The above discussed methodologies are only exemplary techniques of identifying or using the company information of the user of the device 200.

The crawler module 210 may receive instructions from the processor(s) 102 to derive insights about the company which was identified in the previous embodiment or any other companies. The crawler module 210 may crawl through the web page(s) of a company whose sentiment or preference has to be identified. The crawler module 210, for example may crawl through a recruitment page(s) of the company and identify current job openings in the company and the number of openings, thereby identifying whether the company is actively hiring candidates or not, and if the company is hiring, then determine the quantum of candidates desired to be hired. The crawler module 210 may be configured to crawl through web pages or websites that are independent of the company to identify the sentiment of the company. As an example, the crawler module 210 may crawl through one or more of news, press release, job search, business tracking websites to determine the sentiment of the company. The sentiment of the company may include, as an example, indications of hiring by the company or retrenchment of employees. As an example, a press release by the company mentioning plans of increasing its workforce indicates that the company is going to hire candidates.

The activity monitoring module 212 may include instructions, which when executed by the processor(s) 102, causes the processor(s) 102 to monitor the activities of the company within the system 100 in the past to identify preferences of the company. The activity monitoring module 212 may monitor activities of the company and may determine preferences of the company, as an example, one or more of companies from which the current company hires (preferred companies to hire from), skill set and corresponding salary packages of job seekers (preferred salary packages) whose job profiles the company shortlists for hiring, calendar periods during which the company hires, locations of candidates the company prefers to hire from and education background of candidates the company prefers to hire, among others.

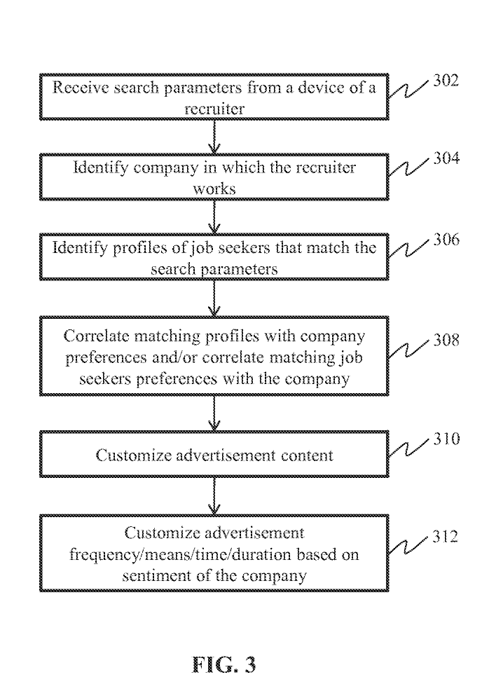

Now also referring to FIG. 3, the customization module 202 may customize digital advertisements and customize strategy for targeting the customized digital advertisements. As an example, at step 302, the search parameter module 206 may receive or use search parameters used by a user of the first user device 200 to carry out a search for profiles of job seekers. The search parameters may also be available to the search parameter module 206 from platforms, such as social networking websites or search engines independent of the system 100. At step 304, the company identification module 214 may identify the company to which the first user device 200 corresponds or the user of the first user device 200 works for.

At step 306, the processor(s) 102 may execute instructions to identify profiles of job seekers present in the candidate database 204 that match the search parameters. As an example, the search parameter may include “JAVA programmers with 2 years of experience currently located in Bangalore”. The processor(s) 102 may identify thousands of profiles from the candidate database 204 that may match the search strings/parameters.

At step 308, the customization module 202 may correlate matching profiles with company preferences. Additionally or alternatively, the customization module 202 may correlate matching job seekers preferences with the company. Additionally or alternatively, the customization module 202 may correlate matching profiles with company preferences and correlate matching job seekers preferences with the company.

At step 310, the customization module 202, based on the above correlation, customizes advertisement content.

In an embodiment, the customized advertisement content derived by the customization module 202 may include information indicating presences of profiles that match the company's preference. It may be noted that, “company's preference” in this context is derived by the system 100 and may not be explicitly stated by the company. The customized advertisement content may also include presences of profiles that match one or more search parameters.

In another embodiment, the customized advertisement content derived by the customization module 202 may include information indicating presences of profiles that match job seekers' preference. The customized advertisement content may also include presences of profiles that match one or more search parameters.

In an embodiment, the customized advertisement content derived by the customization module 202 may include information indicating presences of profiles that match the company's preference and job seekers' preference to work in the company. The customized advertisement content may also include presences of profiles that match one or more search parameters.

The correlation may be described in further details using examples as hereunder. The processor(s) 102 may identify presence of several profiles matching the search parameters used by a recruited of Company A. The customization module 204 may then use information about Company A's preference, such as, a relatively high tendency (based on historical data) of Company A hiring/short listing candidates from another Company B. The processor(s) 102 may then identify that a part of the profiles (as an example, 10 profiles) that matched the search parameters are currently employed in Company B. The customization module 204 may use the current finding to customize advertisement content, which may include a statement, such as, “Access profiles of 10 JAVA programmers with 2 years of experience currently located in Bangalore, and working with Company B”.

Extrapolating the above example, out of the matching profiles working with Company 10, a section of them (as an example, 5 job seekers) may have expressed interest (job seeker's preference) in working with Company A. The customization module 204 may use the current finding to customize advertisement content, which may include a statement, such as, “Access profiles of 10 JAVA programmers with 2 years of experience currently located in Bangalore, and working with Company B, out of which 5 candidates are interested in working with Company A”. Such customized advertisement has the potential of increasing return on investment on digital advertising campaigns.

In another example, from the insights (company preference) derived about Company A, the processor 102 may also understand that company A is interested in hiring candidates whose desired or current salary package may be within a certain range. The customization module 204 may customize the advertisement content to indicate presence of profiles of job seekers which match the instant preference of the Company A. As an example, the customized advertisement content may state, “Access profiles of 10 JAVA programmers with 2 years of experience, whose salaries range between INR 300000 and INR 400000 per annum”.

In yet another example, from the insights derived about company A, the processor 102 may also understand that company A is interested in hiring candidates only from another Company B and may offer a salary package between the range of X and Y. The customization module customizes the advertisements for company A showing profiles of candidates who are currently working or who might have previously worked with company B and used to draw a salary/salaries within or less than the range that company A prefers.

In yet another example, a candidate P's profile, who may be working with or who may have previously worked with company B, may indicate that his company of preference is company A. The customization module 204 would customize the advertisement for company A showing candidate P's profile as a suitable profile and indicating that P is interested in company A.

In yet another example, the insights derived about company A indicates that company A might be looking to hire candidates from a company of preference, which is company B. Also the processor 102 may have information that a candidate P from company B may only prefer an offer from company A. The advertisements would thus be customized for company A, showing profile of candidate P from company B.

Further, the customization module 204, at step 312, may also customize the advertisement frequency based on the sentiment of the company, which may be derived based on information gathered by the crawler module 210. As an example, the insights (sentiment) derived about company A and company B may indicate that company A is actively looking at hiring suitable candidates within a period of one month from the date of publication of such information within their own website or a third party website, whereas company B is not as active as company A with respect to hiring. The customization module 204 may display advertisements to company A at least ten times a day for a certain number of days. Alternatively, the customization module 204 may display two advertisements per day to company B for certain duration of time. In an embodiment, the customization module 204 decides the one or more of frequency, means, time and duration, among others, of displaying the customized advertisement content, based on one or more of activeness of the company in hiring, quantum of hiring and the urgency in hiring (based on one or more of hire by date), among other parameters.

The customization module 204 may further customize the advertisement time. As an example, the insights derived about company A and company B indicate that company A is actively looking at hiring suitable candidates whereas company B is not as active in the search as company A. The customization module 204 may customize the time of advertisements, such as, display five advertisements between 10 am and 12 pm to company A and display one advertisement 10 am and 12 pm to company B.

The customization module 204 may further customize the advertisement means, such as, display the advertisement on social networking platforms based on the insights of the company.

It shall be noted that the customization module 204 is not limited to the examples above and the customization may apply to different parameters/inputs (search parameters, sentiments) individually or in combination that may be taken into consideration to customize the advertisements.

It shall be noted that the processes described above is described as sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

We claim:

1. A system for targeting digital advertisements, the system comprising one or more processors configured to:
gather information corresponding to search parameters used by a first user device;
identify a company to which the first user device corresponds to or a company in which user of the first user device is employed; and
customize advertisement at least based on the search parameters and insight derived about the identified company.

2. The system according to claim 1, wherein the information corresponding to search parameters is gathered through cookies present in the first user device.

3. The system according to claim 1, wherein the information corresponding to search parameters is gathered through inputs received from one or more search engines.

4. The system according to claim 1, wherein the information corresponding to search parameters is received from inputs entered into the system.

5. The system according to claim 1, wherein the company to which the first user device corresponds to is identified from the network information corresponding to the first user device.

6. The system according to claim 1, wherein the company in which the user of the first user device is employed is identified from social networking profile of the user.

7. The system according to claim 1, wherein the advertisements are customized based on preference of the company.

8. The system according to claim 7, wherein the preference of the company comprises one or more of preferred companies to hire from and preferred salary.

9. The system according to claim 7, wherein content of advertisement is customized based on the preference of the company.

10. The system according to claim 1, wherein the advertisements are customized based on sentiment of the company.

11. The system according to claim 10, wherein at least one of frequency of displaying advertisement, time of displaying advertisement, means of displaying advertisement and period of displaying advertisement is based on the sentiment of the company.

12. The system according to claim 10, further comprising a crawler module configured to crawl through one or more web pages to derive sentiment of the company.

13. The system according to claim 1, wherein the advertisements are customized based on preference of job seekers.
